(19) United States
(12) Patent Application Publication
(10) Pub. No.: US 2004/0245168 A1
(43) Pub. Date: Dec. 9, 2004

(54) Universal porous unit

(76) Inventor: James Lowell Jordan, Riverside, CA (US)

Correspondence Address: James Lowell Jordan, 1971 Camden Street, Riverside, CA, 92506, US

(21) Appl. No.: 10/452,010

(22) Filed: Jun. 3, 2003

(51) Int. Cl. B01D 24/38

(52) U.S. Cl. 210/464

(57) ABSTRACT

A universal porous unit whose edges are metallic foil, or metallic foil and polymeric film laminate, or metallic foil and porous membrane, or metallic foil and polymeric film and porous membrane, held together by heat sealing and/or adhesive, or any other method to attach them, so that one or both surfaces of the laminate is/are metallic foil. Metallic foil in the rim can be on one side, the other surface being polymeric film or porous membrane. Metallic foil can be on both sides, the polymeric film or porous membrane being between the two metallic foils. The metallic foil serves to hold and conform the unit to the item to which it is applied and the diaphragm is porous for filtering, screening, or straining. The universal porous unit can be used in home, clinical, industrial, and construction settings to serve as a disposable, easy-to-use, compact, economical filtering, screening, or straining device.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to a universal detachable porous unit that is disposable, lightweight, and easy to use, containing a central filter, mesh, strainer or screen surrounded by a metallic foil, metallic foil-polymeric laminate, or polymeric film, for use in packaging, covering, transporting, screening, filtering, or straining.

### BACKGROUND OF THE INVENTION

### Filters, Strainers, and Screens in General

Using filters, strainers and screens has been practiced from prehistory, the earliest use of filters could have been the use of plant materials. Over time, as materials and methods have advanced, so have filters and strainers. Filters and strainers are now made out of a wide variety of materials, albeit progress is still being made in their development. Most often filters or strainers are usually made to conform specifically to the shape of a container, tube, pipe, or surface, rendering their use across different items or for various uses often impossible, if not extremely difficult, even when the unit is disposable, easy to use, or lightweight. Moreover, a number of materials have been developed for the use as needed to strain and filter materials; these include cheesecloth, filter papers, glass wool, films, screens, and polymeric meshes. When meshes are used, different materials may be used for straining compositions, but also be used to become packaging materials for other items. As such, a filter or strainer device can have the following functions: separate out some material from the rest of the contents, drain fluid from a larger item, keep vectors from affecting the covered item, serve as cover to keep an article inside without blocking air or water exposure and/or serve as packaging material. While many filters and straining devises have been developed, a notable limitation exists. There is a dearth in the development of filter and strainer systems that can be applied to different containers, surfaces, or uses in which the filter or strainer conforms, but still be affixed to, the shape of the article to which the unit is applied. Actually, no devices have been patented, are marketed, or can be located, which serve to filter or strain (depending upon the porosity of the filter or strain), can readily be affixed to and removed from a variety of items, and be disposable. This invention is disposable; lightweight; efficient; effective; inexpensive to manufacture; amenable to being sterilized; applicable to a wide variety of uses and markets—household, industry, construction, agriculture, healthcare, and laboratory—; conformable to incorporating a wide variety of screens with different degrees of chemical and physical properties and tolerances; and, easy to apply, use, and remove. Unlike other filter, screening, and straining systems that have been produced before, this unit is not dependent upon the shape or characteristics of the container, vessel, or item to which it is being applied. Thus, it can also be used in emergency repair situations when preformed filters, screens, or strainers are unavailable. A device like this invention is currently unavailable.

### Prior Art References Related to Invention (as per IDS/PTO-1449): None

### U.S. Patent Documents Cited in Background of Invention: None—New Concept

### BACKGROUND OF INVENTION—OBJECTS AND ADVANTAGES

Accordingly, besides the objects and advantages of serving to filter, screen, or strain materials, several objects and advantages of the present Patent Application of James Lowell Jordan for the “Universal Porous Unit” invention are:

(a) to provide a unit for filtering, screening, or straining which can be produced in a variety of colors and materials without requiring the manufacture to develop materials that are not already currently and commonly used;

(b) to provide a unit which may be used to provide a porous cover for containers allowing for gaseous, solid and liquid exchange with the external environment;

(c) to provide a porous membrane unit whose production can be done in continuous rolls, from which the actual filter, screen, or straining units may be extracted singularly, as sheets, or as rolls, by the use of either a cutting implement or perforations;

(d) to provide a porous membrane unit that can be packaged individually, when sterility is desired, or in stacks;

(e) to provide a porous membrane unit whose inner membrane is porous and external metallic foil/polymeric film laminate, or porous membrane/metallic foil, or metallic foil, can be readily adapted not only by size, but also according to the item being covered;

(f) to provide a porous membrane unit that serves as an effective filter, screen, or strainer unit that can either be reused or disposed of, as the situation requires;

(g) to provide a porous membrane unit that is not only easy to apply, but also easy to remove;

(h) to provide a porous membrane unit that may be made in an infinite number of shapes and patterns, including, but not limited to, oval, circular, rectangular, triangular, square, pentagonal, hexagonal, and continuous sheet;

(i) to provide a porous membrane unit which can be constructed from absorbent material so that, when used, it can be used as a selective or nonselective filter, screen, or strainer;

(g) to provide a porous membrane unit which can also be used as a wrap; in that the rim (edges) of the unit are deformable, items may be placed upon the film and the outer edges twisted to form a seal around the object;

### BRIEF SUMMARY OF THE INVENTION

In accordance with the present invention a cover comprising of a porous membrane with an external metallic foil—polymeric film laminate, or external metallic foil—porous membrane laminate, or metallic foil alone, in which the metallic foil serves to secure the porous membrane in place and the porous membrane serves to act as the filter, screen, or strainer.

It is another object of the present invention to provide a porous membrane unit which minimizes or eliminates contamination—by filtering, screening, or straining—either of contents covered or from the contents being covered.

The above, and other objects of the present invention are achieved, in a preferred embodiment of the present invention, by providing a universal porous unit which incorporates the beneficial components of porous materials with those of metallic foils. The internal diaphragm itself being composed of the porous material—the porosity of which being determined by the actual desired application of the unit—and the external rim being composed of a metallic foil affixed to the porous membrane to form a laminate, of a metallic foil affixed to a polymeric material, or metallic foil alone. The metallic foil is deformable and holds the porous unit in place. The preferred embodiments of the present invention utilize a flat porous film, in sheet-form, to form a membrane having a uniform thickness—the thickness being dependent upon the material being used, the porosity of the material, and the intended surface or opening to be covered by the unit. The porosity may be fine enough to be of use in laboratory settings for microbiological or chemical filtering or of a mesh large enough to be used with much larger items. A region of polymeric film by itself may be incorporated into the unit when a tighter seal is desired between the universal porous unit and the article or the article's orifice. Since surfaces and openings come in a wide variety of sizes, the size of the unit itself, the internal diaphragm, and the external rim also vary accordingly. Thus, the universal porous unit can be made from a few millimeters in size, while another may be made large enough to cover one of several meters in size.

### DRAWINGS—FIGURES

The above, and other embodiments of the present invention, may be more fully understood from the detailed description taken together with the accompanying drawings illustrating examples wherein similar reference characters refer to similar elements in which:

FIG. 1 illustrates a round universal porous unit in which the metallic foil rim-porous membrane laminate edge completely encircles the porous diaphragm interior;

FIG. 2 illustrates a round universal porous unit in which the metallic foil rim completely encircles a metallic foil-porous membrane laminate region which completely encircles the porous diaphragm interior;

FIG. 3 illustrates a round universal porous unit in which the metallic foil-polymeric film rim completely encircles a polymeric foil-porous membrane laminate region which completely encircles the porous diaphragm interior;

FIG. 4 illustrates a round universal porous unit in which the metallic foil-polymeric film rim completely encircles a polymeric film region which encircles a polymeric film-porous membrane laminate region which completely encircles the porous diaphragm interior;

FIG. 5 illustrates a round universal porous unit in which the metallic foil rim completely encircles a metallic foil-polymeric film region which encircles a polymeric film region which encircles a polymeric film-porous membrane laminate region which completely encircles the porous diaphragm interior;

FIG. 6 illustrates a universal porous unit with the metallic foil-porous membrane laminate on two edges only and the porous membrane between those edges;

FIG. 7 illustrates a universal porous unit with metallic foil on the two outer edges, metallic foil-porous membrane laminate as the intermediate regions, and the porous membrane between the metallic foil-porous membrane laminate regions;

FIG. 8 illustrates a universal porous unit with metallic foil-polymeric film laminate on the two outer edges, polymeric film-porous membrane laminate as the intermediate regions, and the porous membrane between the metallic foil-porous membrane laminate regions;

FIG. 9 illustrates a universal porous unit with metallic foil-polymeric film laminate on the two outer edges, polymeric film as the adjacent intermediate regions, polymeric film-porous membrane laminate as the next intermediate region and the porous membrane between the polymeric film-porous membrane laminate regions;

FIG. 10 illustrates a universal porous unit with metallic foil on the two outer edges, metallic foil-polymeric film laminate as the first intermediate region, polymeric film as the next intermediate region, polymeric film-porous membrane laminate as the next regions, and the porous membrane between the metallic foil-membrane laminate regions;

FIG. 11 illustrates the cross section of a laminate edge consisting of one porous layer and one metallic foil layer;

FIG. 12 illustrates the cross section of a laminate edge consisting of one porous layer and one polymeric film layer;

FIG. 13 illustrates the cross section of a laminate edge consisting of a polymeric film layer sandwiched between a porous layer and a metallic foil layer;

FIG. 14 illustrates the cross section of a laminate edge consisting of a metallic foil layer sandwiched between a porous layer and a polymeric film layer;

FIG. 15 illustrates two metallic foil layers sandwiching a porous membrane layer.

### DRAWINGS—REFERENCE NUMERALS

1. Porous membrane

2. Laminate composed of porous membrane attached to metallic foil

3. Metallic foil

4. Laminate composed of porous membrane attached to polymeric film

5. Laminate composed of metallic foil attached to polymeric film

6. Polymeric film

### DESCRIPTION OF THE PREFERRED EMBODIMENTS

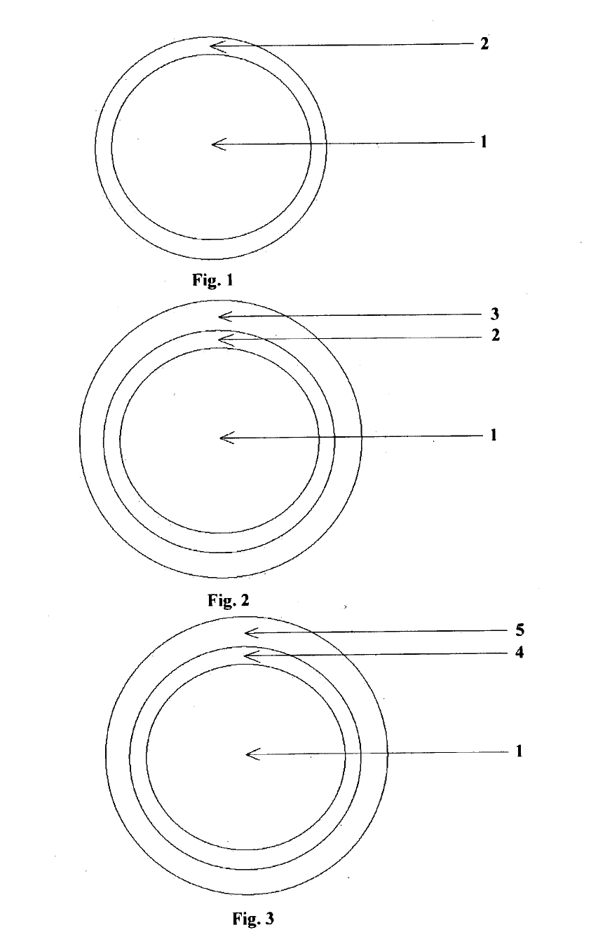

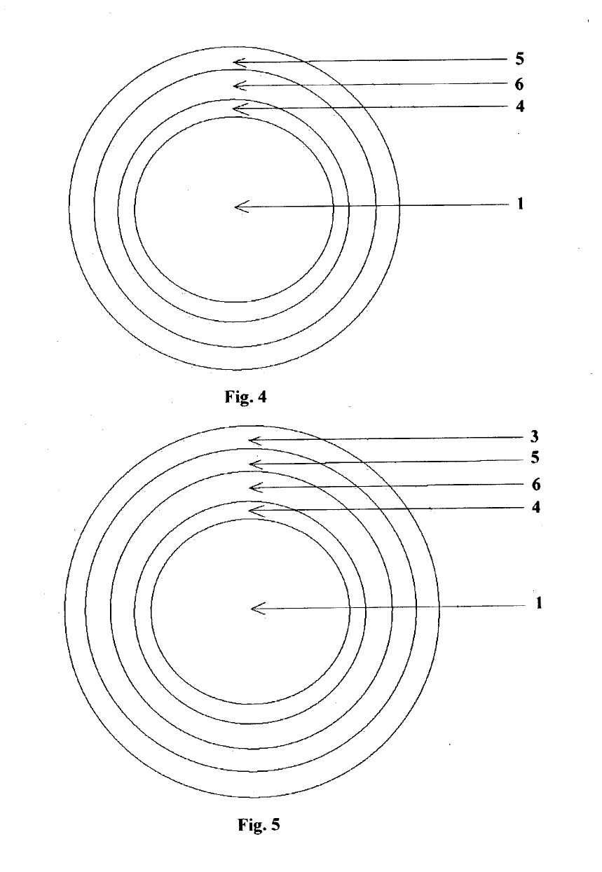

Referring now to the Drawings, there is shown in FIG. 1 a universal porous unit with the metallic foil—porous membrane laminate edge completely encircling the porous diaphragm. There is shown in FIG. 2, a universal porous unit with a metallic foil rim encircling a metallic foil—porous membrane laminate region which then completely encircles the porous diaphragm. There is shown in FIG. 3, a universal porous unit with a metallic foil—polymeric film laminate encircling a polymeric film region which then completely encircles the porous diaphragm. There is shown in FIG. 4, a universal porous unit with a metallic foil—polymeric laminate outer rim encircling a polymeric film region which encircles a polymeric film—porous membrane region which then completely encircles the porous diaphragm. There is shown in FIG. 5, a universal porous unit with a metallic rim encircling a metallic foil—polymeric laminate region encircling a polymeric film region which encircles a polymeric film—porous membrane region which then completely encircles the porous diaphragm. The universal porous units shown in FIGS. 1 to 5 would be useful on use on containers, tubing, and piping when filtering, screening, or straining are desired to or from that particular item. The units shown in FIG. 1 may also serve as temporary covers or as packaging units, when aeration or exposure to a fluid, of a vessel's contents are desired.

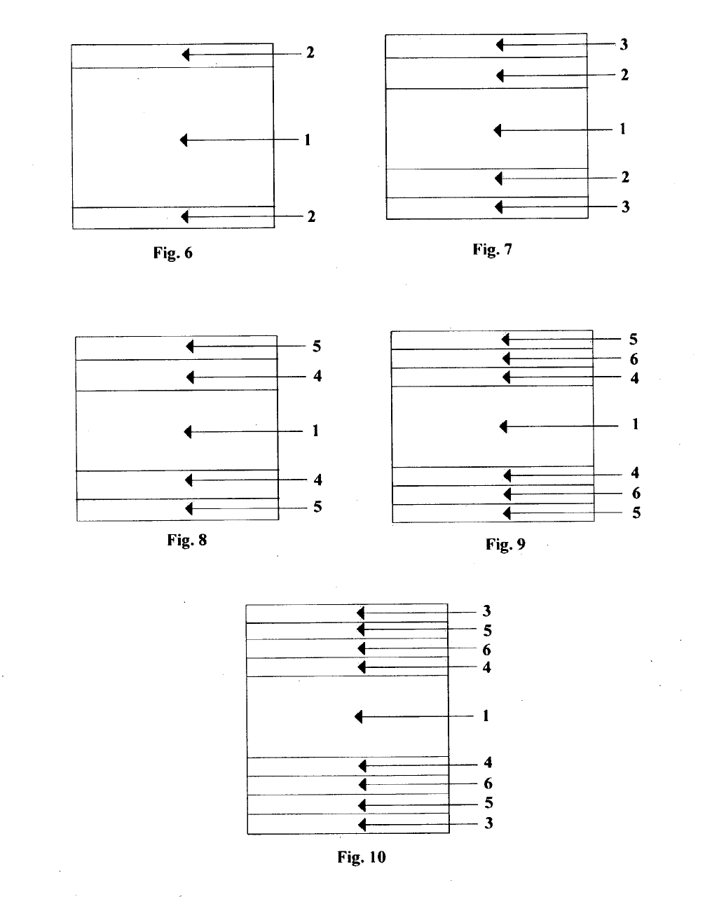

A universal porous unit with metallic foil—porous membrane laminate on two edges only, and the porous membrane region between them, is shown in FIG. 6. There is shown in FIG. 7 a universal porous unit with both outer edge regions metallic foil, the regions adjacent to them being metallic foil—porous membrane laminate, and the porous membrane region being between the two metallic foil—porous membrane laminate regions. There is shown in FIG. 8 a universal porous unit with both outer edge regions metallic foil—polymeric laminate, the regions adjacent to them being polymeric film—porous membrane laminate, and the porous membrane region being between the two polymeric film—porous membrane laminate regions. There is shown in FIG. 9 a universal porous unit with both outer edge regions metallic foil—polymeric film laminate, the regions adjacent to them being polymeric film, the next region being polymeric film—porous membrane laminate, and the porous membrane region being between the two polymeric film—porous membrane laminate regions. There is shown in FIG. 10 a universal porous unit with both outer edge regions are metallic foil, the adjacent regions being metallic foil—polymeric film laminate, the regions adjacent to the metallic foil—polymeric film laminate being polymeric film, the next region being polymeric film—porous membrane laminate, and the porous membrane region being between the two polymeric film—porous membrane laminate regions. The universal porous membrane illustrated in FIGS. 6-10 may be used as a cover for surfaces or when larger filtering, screening, or straining areas are desired than would be present in the units described in FIGS. 1-5. The universal porous membrane units shown in FIGS. 1-10 can be used to wrap materials.

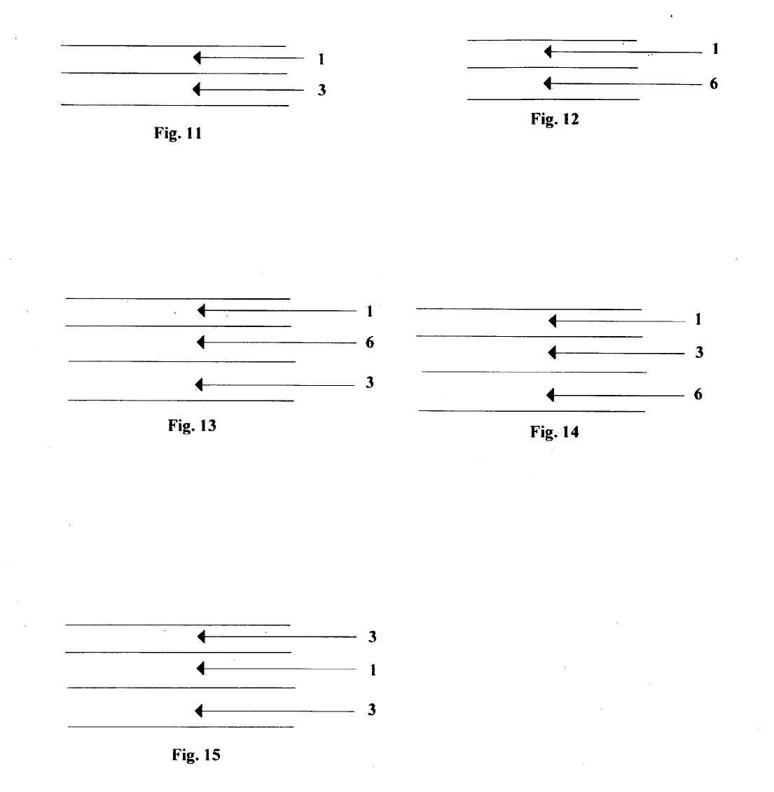

The laminates utilized in this invention are shown in FIGS. 11-15. FIG. 11 shows a laminate of porous membrane and metallic foil. FIG. 12 shows a laminate of porous membrane and polymeric film. FIG. 13 shows a laminate of porous membrane, polymeric film, and metallic foil, with the polymeric film being the innermost layer. FIG. 14 shows a laminate of porous membrane, metallic foil, and polymeric film, with the metallic foil being the innermost layer. FIG. 15 shows a laminate of metallic foil, porous membrane, and metallic foil, with the porous membrane being the innermost layer.

The metallic foil and polymeric material of the universal porous units shown in FIGS. 1 to 10 are affixed to each other by heat, pressure and/or adhesive.

The polymeric material, in FIGS. 1 to 10, can be successfully constructed from a number of materials including latex rubber, cis-1,4-polyiosprene, cis-polybutadiene, neoprene rubber, nitrile rubber, silicone rubber and mixtures thereof, cellulose acetate plastic, vinyl plastic, polyethylene plastic, polypropylene plastic, polyvinyl chloride plastic, polyvinyl acetate plastic, polystyrene plastic, polymethyl methyl-acrylate plastic, polyacrylonitrile plastic, vinyllite plastic, saran plastic, polytetrafluoroethylene plastic, polytrifluorochloroethylene plastic, polycaprolactam plastic, polyester plastic, urea formaldehyde plastic, polyurethane plastic, isotactic polypylene plastic, nylon plastic, rayon plastic, polyamide plastic, phenolic plastic, silicone plastic, silk fiber, cotton fiber, cellulose fiber, wool fiber, animal skin, animal intestinal tissue, animal connective tissue, metallic fiber, mineral fiber, metallic-polymeric combinations designed to reduce static electricity, compositions incorporating agents with regard to antimicrobial activity, any manmade material, any plant material, any animal material, and mixtures thereof.

The metallic foil, in FIGS. 1 to 10, that may be used in this invention include aluminum, aluminum alloys, copper, copper alloys, iron, iron alloys, zinc, zinc alloys, lithium, lithium alloys, lithium, lithium alloys, tin, tin alloys, nickel, nickel alloys, molybdenum, molybdenum alloys, manganese, manganese alloys, titanium, titanium alloys, carbon or silicon compounds that are used to replace metals, and any mixtures and alloys thereof. When the porous membrane or polymeric region is thicker, the metallic foil in the rim must be correspondingly thicker and/or wider to hold the unit in place. When the porous membrane or polymeric film is lighter and thinner, a correspondingly thinner and/or narrower rim may be used.

The filter/screen/strainer interior, in FIGS. 1-10, may be made from a number of compounds. Metallic porous membranes can be made successfully from aluminum, aluminum alloys, copper, copper alloys, iron, iron alloys, zinc, zinc alloys, lithium, lithium alloys, lithium, lithium alloys, tin, tin alloys, nickel, nickel alloys, molybdenum, molybdenum alloys, manganese, manganese alloys, titanium, titanium alloys, carbon or silicon compounds that are used to replace metals, and any mixtures and alloys thereof. Polymeric porous membranes can be made successfully from latex rubber, cis-1,4-polyiosprene, cis-polybutadiene, neoprene rubber, nitrile rubber, silicone rubber and mixtures thereof, cellulose acetate plastic, vinyl plastic, polyethylene plastic, polypropylene plastic, polyvinyl chloride plastic, polyvinyl acetate plastic, polystyrene plastic, polymethyl methyl-acrylate plastic, polyacrylonitrile plastic, vinyllite plastic, saran plastic, polytetrafluoroethylene plastic, polytrifluorochloroethylene plastic, polycaprolactam plastic, polyester plastic, urea formaldehyde plastic, polyurethane plastic, isotactic polypylene plastic, nylon plastic, rayon plastic, polyamide plastic, phenolic plastic, silicone plastic, silk fiber, cotton fiber, cellulose fiber, wool fiber, animal skin, animal intestinal tissue, animal connective tissue,metallic fiber, mineral fiber, metallic-polymeric combinations designed to reduce static electricity, compositions incorporating agents with regard to antimicrobial activity, any manmade material, any plant material, any animal material, and mixtures thereof.

Having described my invention I claim:

1. A unit comprising:
(a) a metallic rim containing one layer or more layers of metallic foil;
(b) an internal porous diaphragm.

2. The metallic rim of claim 1 may be a laminate containing a polymeric film.

3. The metallic rim of claim 1 may be a laminate containing the same material as the internal porous diaphragm.

4. The universal porous unit of claim 1 wherein layers of the outside rim are affixed to each other by heat, pressure, adhesive or any combination of heat, pressure, or adhesive.

5. Any of the following may be used as the “polymeric” film in this invention, as per claim 1: latex rubber, cis-1,4-polyiosprene, cis-polybutadiene, neoprene rubber, nitrile rubber, silicone rubber and mixtures thereof, cellulose acetate plastic, vinyl plastic, polyethylene plastic, polypropylene plastic, polyvinyl chloride plastic, polyvinyl acetate plastic, polystyrene plastic, polymethyl methyl-acrylate plastic, polyacrylonitrile plastic, vinyllite plastic, saran plastic, polytetrafluoroethylene plastic, polytrifluorochloroethylene plastic, polycaprolactam plastic, polyester plastic, urea formaldehyde plastic, polyurethane plastic, isotactic polypylene plastic, nylon plastic, rayon plastic, polyamide plastic, phenolic plastic, silicone plastic, silk fiber, cotton fiber, cellulose fiber, wool fiber, animal skin, animal intestinal tissue, animal connective tissue, metallic fiber, mineral fiber, metallic-polymeric combinations designed to reduce static electricity, compositions incorporating agents with regard to antimicrobial activity, any manmade material, any plant material, any animal material, and mixtures thereof.

6. Any of the following may be used as the metallic film in this invention, as per claim 1: aluminum, aluminum alloys, copper, copper alloys, iron, iron alloys, zinc, zinc alloys, lithium, lithium alloys, tin, tin alloys, nickel, nickel alloys, molybdenum, molybdenum alloys, manganese, manganese alloys, titanium, titanium alloys, carbon or silicon compounds that are used to replace metals, and any mixtures, layerings, and alloys thereof.

7. The filter/screen/strainer interior, may be made from a number of compounds. Metallic porous membranes can be made successfully from aluminum, aluminum alloys, copper, copper alloys, iron, iron alloys, zinc, zinc alloys, lithium, lithium alloys, lithium, lithium alloys, tin, tin alloys, nickel, nickel alloys, molybdenum, molybdenum alloys, manganese, manganese alloys, titanium, titanium alloys, carbon or silicon compounds that are used to replace metals, and any mixtures and alloys thereof. Polymeric porous membranes can be made successfully from latex rubber, cis-1,4-polyiosprene, cis-polybutadiene, neoprene rubber, nitrile rubber, silicone rubber and mixtures thereof, cellulose acetate plastic, vinyl plastic, polyethylene plastic, polypropylene plastic, polyvinyl chloride plastic, polyvinyl acetate plastic, polystyrene plastic, polymethyl methyl-acrylate plastic, polyacrylonitrile plastic, vinyllite plastic, saran plastic, polytetrafluoroethylene plastic, polytrifluorochloroethylene plastic, polycaprolactam plastic, polyester plastic, urea formaldehyde plastic, polyurethane plastic, isotactic polypylene plastic, nylon plastic, rayon plastic, polyamide plastic, phenolic plastic, silicone plastic, silk fiber, cotton fiber, cellulose fiber, wool fiber, animal skin, animal intestinal tissue, animal connective tissue, metallic fiber, mineral fiber, metallic-polymeric combinations designed to reduce static electricity, compositions incorporating agents with regard to antimicrobial activity, any manmade material, any plant material, any animal material, and mixtures thereof.

8. The rim of claim 1:
(a) can completely enclose the porous diaphragm;
(b) be on the edges of the porous film diaphragm without completely enclosing it.
